(19) United States
(12) Patent Application Publication
(10) Pub. No.: US 2026/0304064 A1
(43) Pub. Date: Oct. 1, 2026

(54) ACOUSTIC ADJUSTMENT ASSISTANCE DEVICE, ACOUSTIC ADJUSTMENT DEVICE, ACOUSTIC ADJUSTMENT ASSISTANCE METHOD, AND NON-TRANSITORY RECORDABLE MEDIUM

(71) Applicant: Asahi Kasei Microdevices Corporation, Tokyo (JP)

(72) Inventor: Yuji Honda, Tokyo (JP)

(73) Assignee: Asahi Kasei Microdevices Corporation, Tokyo (JP)

(21) Appl. No.: 19/568,772

(22) Filed: Mar. 16, 2026

(30) Foreign Application Priority Data
Mar. 26, 2025 (JP) 2025-052145

(51) Int. Cl. H04S 7/00; H04S 3/00

(52) U.S. Cl. CPC H04S 7/40; H04S 3/008; H04S 7/302; H04R 2499/13; H04S 2400/01; H04S 2400/11

(57) ABSTRACT

Provided is an acoustic adjustment assistance device, which includes: an acquisition part that acquires signals based on acoustic signals output from a plurality of output channels provided in a vehicle cabin of a vehicle at positions corresponding to both ears of a listener provided in the vehicle cabin; and a generation part that generates display information for display on a display part, the display information showing at least one of a relationship between an interaural level difference and a frequency and a relationship between an interaural phase difference and the frequency in the acoustic signal. The generation part generates the display information showing at least one of a graph showing the relationship between the interaural level difference and the frequency and a graph showing the relationship between the interaural phase difference and the frequency.

### CROSS-REFERENCE TO RELATED APPLICATION

This application claims the priority benefits of Japanese application no. 2025-052145, filed on Mar. 26, 2025. The entirety of the above-mentioned patent application is hereby incorporated by reference herein and made a part of this specification.

### BACKGROUND

### Technical Field

The disclosure relates to an acoustic adjustment assistance device, an acoustic adjustment device, an acoustic adjustment assistance method, and a non-transitory recordable medium.

### Related Art

Patent Document 1 describes “a sound image prediction device and a sound image prediction method capable of predicting a sound image position with high accuracy”.

### Citation List

### Patent Document

Patent Document 1 Japanese Patent No. 7252785

It is desired to easily adjust the output of acoustic signals such that occupants in a vehicle cabin can comfortably listen to acoustic signals output from a plurality of output channels provided in the vehicle cabin.

### SUMMARY

In a first aspect of the disclosure, an acoustic adjustment assistance device is provided. The acoustic adjustment assistance device includes an acquisition part that acquires signals based on acoustic signals output from a plurality of output channels provided in a vehicle cabin of a vehicle at positions corresponding to both ears of a listener provided in the vehicle cabin; and a generation part that generates first display information for display on a display part, the first display information showing at least one of a relationship between an interaural level difference and a frequency and a relationship between an interaural phase difference and the frequency in the acoustic signal.

In a second aspect of the disclosure, an acoustic adjustment device is provided. The acoustic adjustment device includes any of the acoustic adjustment assistance devices; and an adjustment part that adjusts at least one of a level and a phase of the acoustic signals output from the plurality of speakers, respectively.

In a third aspect of the disclosure, an acoustic adjustment assistance method is provided. The acoustic adjustment assistance method includes: acquiring signals based on acoustic signals output from a plurality of output channels provided in a vehicle cabin of a vehicle at positions corresponding to both ears of a listener provided in the vehicle cabin; and generating display information for display on a display part, the display information showing at least one of a relationship between an interaural level difference and a frequency and a relationship between an interaural phase difference and the frequency in the acoustic signal.

In a fourth aspect of the disclosure, a non-transitory storage medium storing a program is provided. The program, when executed by a computer, causes the computer to function as an acquisition part that acquires signals based on acoustic signals output from a plurality of output channels provided in a vehicle cabin of a vehicle at positions corresponding to both ears of a listener provided in the vehicle cabin, and as a generation part that generates display information for display on a display part, the display information showing at least one of a relationship between an interaural level difference and a frequency and a relationship between an interaural phase difference and a frequency in the acoustic signal.

### BRIEF DESCRIPTION OF THE DRAWINGS

FIG. 1 is a block diagram showing an example of a configuration of the acoustic adjustment device 100 of the present embodiment.

FIG. 2 is an example of a schematic top view of the arrangement of speakers and the like in the vehicle cabin of the vehicle 10.

FIG. 3A is an example of a graph showing an interaural level difference and an interaural phase difference heard by an occupant in the vehicle cabin of the vehicle 10.

FIG. 3B is an example of a graph showing waveforms of acoustic signals heard by both ears in domain A.

FIG. 3C is an example of a graph showing waveforms of acoustic signals heard by both ears in domain B.

FIG. 4 is an example of a diagram showing level difference and phase difference heard by both ears for each seat, displayed on the display part 160.

FIG. 5 is an example of a graph showing level difference and phase difference heard by both ears after adjustment by the adjustment part 122, regarding the driver seat information display part 194.

FIG. 6 is an example of displaying an image for showing an interaural phase difference in acoustic signals heard by both ears.

FIG. 7 is an example of displaying an image for showing an interaural level difference in acoustic signals heard by both ears.

FIG. 8 is an example of a diagram showing level difference and phase difference heard by both ears for each seat, displayed on the display part 160.

FIG. 9 is an example of a flow diagram showing processing performed in the acoustic adjustment assistance method according to the present embodiment.

FIG. 10 is an example of a computer 1200 that may wholly or partially embody aspects of the present embodiment.

### DESCRIPTION OF THE EMBODIMENTS

In a first aspect of the disclosure, an acoustic adjustment assistance device is provided. The acoustic adjustment assistance device includes an acquisition part that acquires signals based on acoustic signals output from a plurality of output channels provided in a vehicle cabin of a vehicle at positions corresponding to both ears of a listener provided in the vehicle cabin; and a generation part that generates first display information for display on a display part, the first display information showing at least one of a relationship between an interaural level difference and a frequency and a relationship between an interaural phase difference and the frequency in the acoustic signal.

In the acoustic adjustment assistance device, the generation part may generate the first display information showing at least one of a graph showing the relationship between the interaural level difference and the frequency and a graph showing the relationship between the interaural phase difference and the frequency.

In any of the acoustic adjustment assistance devices, the generation part may generate the first display information showing at least one of the relationship between the interaural level difference and the frequency and the relationship between the interaural phase difference and the frequency in the acoustic signal, for each of the plurality of positions corresponding to both ears of the listener.

In any of the acoustic adjustment assistance devices, the generation part may generate the first display information including an image representing a sound image formed by the acoustic signals output from the plurality of output channels, based on at least one of the relationship between the interaural level difference and the frequency and the relationship between the interaural phase difference and the frequency in the acoustic signal.

In any of the acoustic adjustment assistance devices, the generation part may generate the first display information including the image representing the sound image, based on at least one of statistical information of an interaural level difference and statistical information of an interaural phase difference in a predetermined frequency band.

In any of the acoustic adjustment assistance devices, the generation part may generate the first display information including the image representing the sound image with higher resolution as an interaural level difference is smaller and an interaural phase difference is smaller in a predetermined frequency band.

In any of the acoustic adjustment assistance devices, the generation part may generate the first display information including the image representing the sound image showing that sound source localization is shifted toward a direction of a sound source having faster phase advance as an interaural phase difference in a predetermined frequency band is larger.

In any of the acoustic adjustment assistance devices, the generation part may generate the first display information including the image representing the sound image showing that sound source localization is shifted toward a direction of a sound source having a larger level as an interaural level difference in a predetermined frequency band is larger.

In any of the acoustic adjustment assistance devices, the output channel may be a speaker.

In a second aspect of the disclosure, an acoustic adjustment device is provided. The acoustic adjustment device includes any of the acoustic adjustment assistance devices; and an adjustment part that adjusts at least one of a level and a phase of the acoustic signals output from the plurality of speakers, respectively.

In the acoustic adjustment device, the generation part may update the first display information in response to the adjustment part adjusting at least one of the level and the phase.

In the acoustic adjustment device, the generation part may further generate second display information for display on the display part an input interface via which parameters related to the phase of each of the acoustic signals output from the plurality of output channels are input, the adjustment part may be configured to acquire the parameters related to the phase of the acoustic signal for each of the plurality of output channels via the input interface displayed on the display part, and the generation part may update the first display information in response to the adjustment part adjusting the phase based on the parameters input via the input interface, and may collectively display the updated first display information, the second display information, and the input parameters on the display part.

In a third aspect of the disclosure, an acoustic adjustment assistance method is provided. The acoustic adjustment assistance method includes: acquiring signals based on acoustic signals output from a plurality of output channels provided in a vehicle cabin of a vehicle at positions corresponding to both ears of a listener provided in the vehicle cabin; and generating display information for display on a display part, the display information showing at least one of a relationship between an interaural level difference and a frequency and a relationship between an interaural phase difference and the frequency in the acoustic signal.

In a fourth aspect of the disclosure, a non-transitory storage medium storing a program is provided. The program, when executed by a computer, causes the computer to function as an acquisition part that acquires signals based on acoustic signals output from a plurality of output channels provided in a vehicle cabin of a vehicle at positions corresponding to both ears of a listener provided in the vehicle cabin, and as a generation part that generates display information for display on a display part, the display information showing at least one of a relationship between an interaural level difference and a frequency and a relationship between an interaural phase difference and a frequency in the acoustic signal.

Note that the above summary of the invention does not enumerate all of the features of the disclosure. Sub-combinations of these feature groups may also constitute inventions.

The following embodiments do not limit the invention according to the patent claims. Not all combinations of features described in the embodiments are necessarily essential to the solution of the invention.

In this specification, the expressions amplitude difference and level difference may be used for acoustic signals. The level difference of an acoustic signal is often expressed in dB (decibel) units, which is a logarithmic scale unit, and the term “level difference” is frequently used to compare quantities on a logarithmic scale. Additionally, “acoustic level,” which indicates the magnitude of an acoustic signal on a logarithmic scale, may simply be referred to as level. In this specification, the term “amplitude” may be used when indicating the peak value of the waveform itself of an acoustic signal or the amplitude component of an acoustic signal as a linear quantity. The acoustic signal in this specification refers to a signal that is formed by sound waves propagating through a listening space and is output as sound waves that provide auditory sensation to a listener. The so-called level of an acoustic signal may also be regarded as the sound pressure level at the listening position. Control and adjustment of an acoustic signal refers to an act of controlling the operation of a medium that outputs an acoustic signal, and refers to, for example, signal processing executed to change the characteristics of the output acoustic signal.

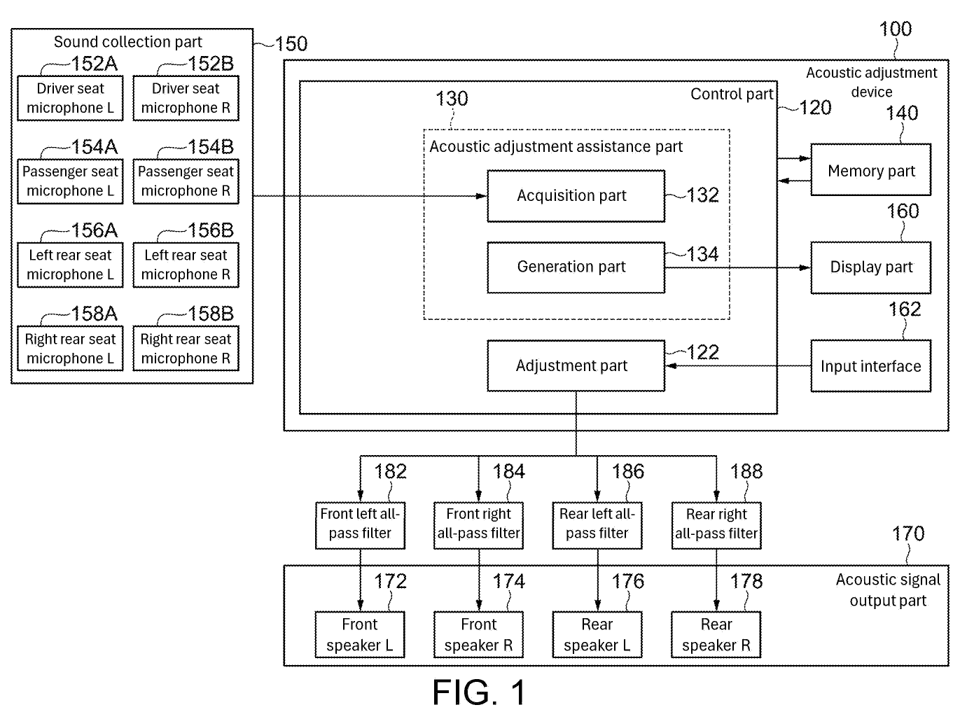

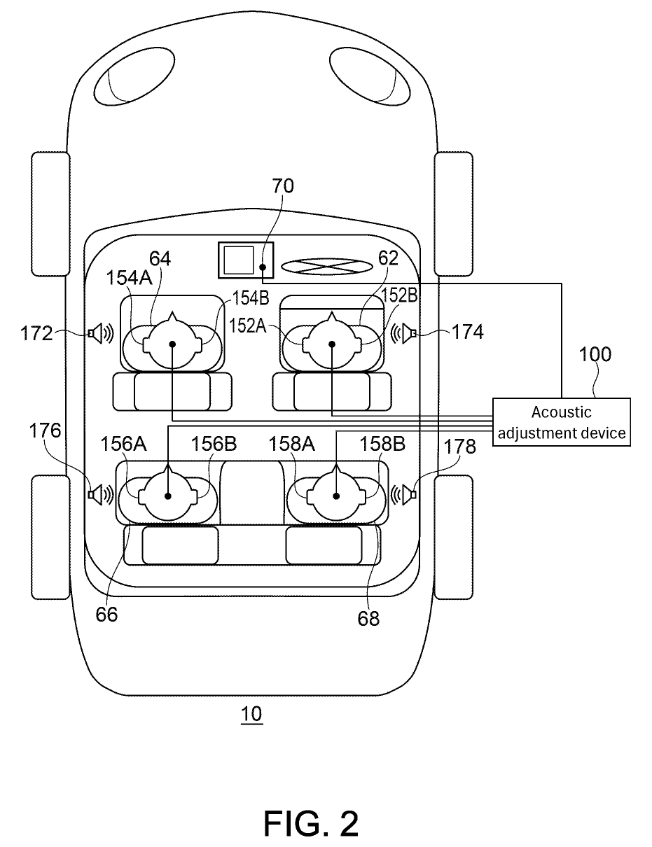

FIG. 1 is a block diagram showing an example of a configuration of an acoustic adjustment device 100 of the present embodiment. The acoustic adjustment device 100 is a device for adjusting the level and phase of acoustic signals heard by occupants of a vehicle 10 in the vehicle cabin of the vehicle 10, which will be described later with reference to FIG. 2. An inspector of the vehicle 10, via the acoustic adjustment device 100, adjusts the acoustic signal output from an acoustic signal output part 170 such that when an occupant is in the vehicle cabin of the vehicle 10, the occupant of the vehicle 10 may comfortably listen to music, audio, and the like heard in the vehicle cabin.

The acoustic adjustment device 100 includes a control part 120, a memory part 140, a display part 160, and an input interface 162. The acoustic adjustment device 100 is also connected to a sound collection part 150. Furthermore, the acoustic adjustment device 100 is connected to a front left all-pass filter 182, a front right all-pass filter 184, a rear left all-pass filter 186, and a rear right all-pass filter 188, and adjusts the settings of the front left all-pass filter 182, the front right all-pass filter 184, the rear left all-pass filter 186, and the rear right all-pass filter 188 to adjust the output of the acoustic signal output part 170.

The control part 120 performs control for adjusting the acoustic signal output into the vehicle cabin of the vehicle 10 and for assisting the adjustment of the acoustic signal. The acoustic adjustment device 100 is, for example, a terminal connectable to the vehicle 10 and the sound collection part 150. The control part 120 includes an acoustic adjustment assistance part 130 and an adjustment part 122.

The acoustic adjustment assistance part 130 assists in adjusting the acoustic signal output into the vehicle cabin of the vehicle 10. The acoustic adjustment assistance part 130 outputs information about the acoustic signal acquired in the vehicle 10 to the display part 160 in order to assist in adjusting the acoustic signal. Thereby, the acoustic adjustment assistance part 130 visualizes information for adjusting the acoustic signal to the occupant of the vehicle 10, enabling the occupant of the vehicle 10 to adjust the acoustic signal via the input interface 162. The acoustic adjustment assistance part 130 includes an acquisition part 132 and a generation part 134. The acoustic adjustment assistance part 130 functions as an “acoustic adjustment assistance device”.

The acquisition part 132 acquires, from the sound collection part 150, a signal based on the acoustic signal collected by the sound collection part 150 at positions corresponding to both ears of a listener provided in the vehicle cabin. Thereby, the acquisition part 132 acquires, by the sound collection part 150 installed at positions corresponding to both ears of the listener in the vehicle cabin, a signal based on the acoustic signal output from a plurality of output channels (for example, a front left speaker 172, a front right speaker 174, a rear left speaker 176, and a rear right speaker 178) provided in the vehicle cabin of the vehicle 10. One speaker may be assigned to one output channel. Also, a plurality of speakers installed at approximately the same position may be assigned to one output channel.

The generation part 134 generates display information to be displayed by the display part 160 for adjusting the acoustic signal heard by the occupant of the vehicle 10 (that is, synonymous with the listener in the vehicle cabin), based on the signal acquired by the acquisition part 132. In particular, the generation part 134 may generate display information (first display information) to be displayed on the display part 160, showing at least one of a relationship between an interaural level difference and frequency and a relationship between an interaural phase difference and frequency in the acoustic signal. Also, the generation part 134 may generate second display information for display on the display part 160 the input interface 162 via which parameters related to the phase of each acoustic signal output from a plurality of output channels are input, and may realize the adjustment part 122 described later. In the following, unless otherwise specifically mentioned, the first display information is simply described as display information.

The adjustment part 122 adjusts the acoustic signal output by the acoustic signal output part 170. The adjustment part 122 may adjust each speaker with respect to at least one of the volume level (or amplitude), phase, and the like of the acoustic signal output from the acoustic signal output part 170 including a plurality of speakers. Here, the volume level refers to the magnitude of the acoustic signal quantified on a logarithmic scale. The adjustment part 122 may adjust the acoustic signal output by the acoustic signal output part 170 based on input via the input interface 162 by an inspector (a person who performs the adjustment).

The memory part 140 is a storage device for storing data and the like for adjusting the acoustic signal to be output. The memory part 140 may be configured with, for example, a non-transitory storage medium.

The sound collection part 150 is the sound collection part for collecting an acoustic signal corresponding to the acoustic signal heard by the occupant in the vehicle cabin, that is, for collecting the acoustic signal at positions corresponding to both ears of a listener provided in the vehicle cabin. For this purpose, the sound collection part 150 may be provided in, for example, a simulator called a Head and Torso Simulator (HATS) that reproduces the acoustic characteristics of an adult head and torso simulating the upper body of an average adult human.

As described later with reference to FIG. 2, the vehicle 10 of the present embodiment is described taking as an example a vehicle that accommodates four occupants. The sound collection part 150 of the present embodiment collects acoustic signals at positions corresponding to both ears of each of the four occupants for each seat of the four occupants. Therefore, the sound collection part 150 includes, for sound collection for the front seats of the vehicle, a driver seat left microphone (driver seat microphone L) 152A and a driver seat right microphone (driver seat microphone R) 152B (which may be collectively referred to as driver seat microphone 152), and a passenger seat left microphone (passenger seat microphone L) 154A and a passenger seat right microphone (passenger seat microphone R) 154B (which may be collectively referred to as passenger seat microphone 154). Furthermore, the sound collection part 150 includes, for sound collection for the rear seats of the vehicle, a left rear seat left microphone (left rear seat microphone L) 156A and a left rear seat right microphone (left rear seat microphone R) 156B (which may be collectively referred to as left rear seat microphone 156), and a right rear seat left microphone (right rear seat microphone L) 158A and a right rear seat right microphone (right rear seat microphone R) 158B (which may be collectively referred to as right rear seat microphone 158). The sound collection part 150 outputs a signal based on voltage or current based on the acoustic signal collected at each of the sound collection parts 150 to the acquisition part 132.

The display part 160 displays a graph and/or image and the like based on the first display information generated by the generation part 134. The display part 160 may be provided as a part of the acoustic adjustment device 100, and may be provided by any monitor. The display part 160 also displays the input interface 162 based on the second display information generated by the generation part 134.

The input interface 162 is an interface for inputting instruction information for the adjustment part 122 to adjust the acoustic signal output from the acoustic signal output part 170. The input interface is displayed based on the second display information generated by the generation part 134. An occupant of the vehicle 10 or an inspector of acoustic adjustment may input instruction information for adjusting the acoustic signal output by the acoustic signal output part 170 based on the display by the display part 160. The input interface 162 is implemented by a device having a display function and an input function, such as a touch panel, and this device may be configured as the display part 160.

The acoustic signal output part 170 is a device that collectively refers to speakers for receiving an acoustic signal including audio of music, radio, or video and the like from a content distribution part (not shown) and outputting the acoustic signal into the vehicle cabin of the vehicle 10. The acoustic signal output part 170 is configured to be able to receive a signal from the acoustic adjustment device 100 as well, and may output an acoustic signal (described later) used for acoustic adjustment. The acoustic signal output part 170 includes the front left speaker (front speaker L) 172, the front right speaker (front speaker R) 174, a rear left speaker (rear speaker L) 176, and the rear right speaker (rear speaker R) 178. As described above, in the present embodiment, one speaker is provided on each of the left and right sides for the front seats in the traveling direction of the vehicle 10, that is, two speakers are provided for the front seats, and similarly, one speaker is provided on each of the left and right sides for the rear seats, that is, two speakers are provided for the rear seats. However, the number of speakers provided in the vehicle cabin is not limited to four, and it is sufficient that a plurality of speakers are provided, and the technology of the present embodiment may be applied to the vehicle 10 provided with any number of two or more speakers.

Music, audio, and the like output by the acoustic signal output part 170 into the vehicle cabin of the vehicle 10 may be controlled by a digital signal processor (DSP). The DSP outputs a digital signal based on music, audio, and the like recorded as an audio source to a DAC (Digital-to-Analog Converter). The DSP may control music, audio, and the like output by the acoustic signal output part 170 into the vehicle cabin of the vehicle 10 by incorporating an IIR (infinite impulse response) filter and/or an FIR (finite impulse response) filter. For example, the DSP executes so-called “equalizing” control that specifies a frequency range to be controlled and adjusts the volume level by controlling the IIR filter and/or the FIR filter. Regarding volume control by equalizing, either raising or lowering the volume level over a relatively wide range of frequencies, or adjusting the volume level for a specific frequency range preset according to the characteristics of detected noise may be executed.

The front left all-pass filter (FL APF) 182, the front right all-pass filter (FR APF) 184, the rear left all-pass filter (RL APF) 186, and the rear right all-pass filter (RR APF) 188 are filters for adjusting the phase of the acoustic signal output by the front left speaker 172, the front right speaker 174, the rear left speaker 176, and the rear right speaker 178 included in the acoustic signal output part 170. The all-pass filter functions as a filter that does not change the amplitude corresponding to the volume level of the acoustic signal output by the acoustic signal output part 170, but changes only the phase characteristics.

The front left all-pass filter 182, the front right all-pass filter 184, the rear left all-pass filter 186, and the rear right all-pass filter 188 may be configured by the FIR filter and/or the IIR filter included in the DSP. In the case of performing phase correction with an analog circuit, the circuit scale often becomes large, but in a digital circuit, the phase characteristics may be flexibly changed by changing the filter coefficient.

The adjustment part 122 of the present embodiment may control the level of the acoustic signal output by the acoustic signal output part 170 per frequency through the equalizing control of the DSP by controlling the IIR filter and/or the FIR filter of the DSP. Furthermore, the adjustment part 122 of the present embodiment may control the phase output by the speaker by adjusting the setting of the all-pass filter provided for each speaker by controlling the IIR filter and/or the FIR filter of the DSP. In this way, the adjustment part 122 may adjust at least one of the level and the phase of the acoustic signal output by the acoustic signal output part 170.

FIG. 2 shows an example of a schematic top view of the arrangement of speakers and the like in the vehicle cabin of the vehicle 10. As already described, in the vehicle cabin of the vehicle 10 of the present embodiment, four speakers (the front left speaker 172, the front right speaker 174, the rear left speaker 176, and the rear right speaker 178) are provided. As the vehicle 10 of the present embodiment, a four-seater vehicle 10 is shown. Therefore, as seats in the vehicle cabin of the vehicle 10, a driver seat, a passenger seat, a left rear seat, and a right rear seat are provided.

An occupant in the vehicle cabin of the vehicle 10 sits in any one of the driver seat, the passenger seat, the left rear seat, and the right rear seat in the vehicle cabin to listen to the audio signals output by the four speakers. The sound collection part 150 includes microphones (the driver seat microphone L 152A, the driver seat microphone R 152B, the passenger seat microphone L 154A, the passenger seat microphone R 154B, the left rear seat microphone L 156A, the left rear seat microphone R 156B, the right rear seat microphone L 158A, and the right rear seat microphone R 158B) arranged at positions corresponding to both ears of models 62, 64, 66, 68 provided to simulate the upper body and head of an occupant at each of the driver seat, the passenger seat, the left rear seat, and the right rear seat.

In the case where there is a sound source (for example, a speaker) that outputs an acoustic signal, the ears of a listener who listens to the sound from the sound source exist on the left and right sides of the listener's head. Due to the left-right difference in the positions of both ears on the listener's head, a sound pressure difference and/or a time difference may occur in the acoustic signal being listened to. The listener of the acoustic signal recognizes the position of the sound source relative to the listener as “sound source localization” based on this sound pressure difference and/or time difference. Moreover, the listener of the acoustic signal perceptually perceives the position, size, shape, and the like of the sound source, and perceives the perceptual image of the sound source as a “sound image”. In this case, the listener may perceive the position of the “sound image” as “sound source localization”.

In the present embodiment, a plurality of speakers are provided in the vehicle cabin of the vehicle 10. For example, in a vehicle 10 in which the driver seat is arranged on the right side, such as domestic private vehicles produced in Japan, in the present embodiment, the front right speaker 174 is provided on the right side of the driver seat. On the other hand, the front left speaker 172 is provided on the left side of the passenger seat. The acoustic signal from the speakers is listened to by an occupant sitting in a seat in the vehicle cabin.

For example, in the driver seat, when a driver listens to acoustic signals output from the front left speaker 172 and the front right speaker 174, the distance from each speaker to each ear of the driver is different. In this way, in the vehicle cabin, the distances from a plurality of sound sources to each ear of the listener may be different. Furthermore, due to the arrangement of various objects such as seats, the listener, walls, windows, and the dashboard in the vehicle cabin, the acoustic signals output from the acoustic signal output part 170 reach the listener's ears after undergoing complex reflection and/or absorption by objects in the vehicle cabin, interference between waves, and the like.

In such a case, the sound waves forming the acoustic signal cancel each other out or reinforce each other at various frequencies due to phase shifts between the sound waves and the like, and reach each ear of the listener. In this case, in the acoustic signal listened to by both ears of the listener, a phase difference and/or a level difference may occur between both ears. In particular, the phase difference or level difference occurring in the acoustic signal due to this phenomenon may occur with irregular magnitudes that differ for each pitch of the sound included in the acoustic signal, for example. Therefore, when the listener perceives a sound image in the sound listened to by both ears, the phase difference or level difference occurring with different magnitudes for each pitch may, for example, make the localization of the sound source perceived by the listener ambiguous, and may occur as blur of the sound image perceived by the listener.

When the sound image is unclear, the listener's brain may unconsciously try to search for the direction from which the sound producing the sound image is coming. This may be a burden for the listener of the sound, and the unconscious brain activity associated with the unclear sound image may cause the listener to become fatigued or feel stressed. Moreover, in daily life, humans often live while grasping the localization of sound sources. Therefore, when the listener perceives an unclear sound image, the listener may have a spatial recognition that is more unclear than the spatial recognition in daily life, and this may lead to a sense of anxiety or discomfort for the listener. In particular, in the case of long-term listening, the perception of an unclear sound image may easily cause the listener to become fatigued, and may impose a psychological or physiological burden on the listener.

On the other hand, when the sound image is clear, the listener can clearly perceive the direction and/or distance from which the sound is generated. In this case, the listener can more easily intuitively grasp the position of the sound source related to the perceived sound image, can more easily perceive spatial expanse in the listening experience, and the sense of presence of the experience is also improved. Therefore, when the sound image is clear, a natural and comfortable listening experience is provided.

Moreover, in an audio source that produces the sound to be listened to, sounds from different types of sound sources such as vocals, musical instruments, or environmental sounds, which are sound sources with different timbres, may be recorded. In such a case, when the sound image is clear, the perceptual positions of individual sound sources are clearly distinguished, so it becomes easier to distinguish and listen to sound sources with different timbres, and it also becomes easier for the listener to consciously listen to the sound that the listener wants to hear. Therefore, in this respect as well, when the sound image is clear, a comfortable listening experience is provided for the listener.

Therefore, the adjustment part 122 of the present embodiment adjusts the acoustic signal output by the acoustic signal output part 170 so as to clarify the sound image at each seat in the vehicle cabin of the vehicle 10. In the acoustic signal listened to by both ears of the occupant at each seat in the vehicle cabin, when the level difference and phase difference listened to between both ears are small, the sound image indicated by the listened acoustic signal becomes clear.

When a plurality of speakers are provided as the acoustic signal output part 170, the adjustment part 122 may adjust the acoustic signals output by the plurality of speakers such that the acoustic signals become acoustic signals in which the level difference and phase difference listened to between both ears of the occupant at each seat in the vehicle cabin of the vehicle 10 are canceled out. For this purpose, the generation part 134 generates display information indicating at least one of the relationship between the interaural level difference and frequency and the relationship between the interaural phase difference and frequency. The display part 160 displays a graph and/or image based on the display information.

The adjustment part 122 adjusts such that the interaural level difference and the interaural phase difference in each frequency component of the acoustic signal output by the acoustic signal output part 170 become small at each seat in the vehicle cabin of the vehicle 10.

In this case, at each seat in the vehicle cabin of the vehicle 10, a case where occupants sit in all seats and a case where occupants sit in some of the seats may be considered. As the adjustment mode of the acoustic signal performed by the adjustment part 122, for example, different adjustment modes may be set for a case where occupants sit in all seats, a case where occupants sit in some of the seats such as only the front seats or only the driver seat, and the like.

For example, when occupants sit in all seats, adjustment may be made such that the average of the sound image for individual occupants becomes clear for the occupants at all seats in the vehicle cabin of the vehicle 10. Alternatively, adjustment may be made such that the sum of the level difference or phase difference at each seat becomes minimum.

For example, when occupants sit only in some of the seats, the level difference or phase difference of the acoustic signal output by the acoustic signal output part 170 may be adjusted such that the sound image becomes clear only at the seats where the occupants are sitting.

An inspector views the display information displayed on the display part 160 and causes the adjustment part 122 to perform adjustment such that the interaural level difference or phase difference of the acoustic signal listened to at the seat indicated in the display information becomes small, and the sound image of the acoustic signal output by the acoustic signal output part 170 becomes clear for the occupant of the vehicle 10. The display part 160 and the input interface 162 may be provided in the acoustic adjustment device 100. The inspector instructs the adjustment part 122 via the input interface 162 to reduce the level difference and phase difference of the acoustic signal output by the acoustic signal output part 170.

The acoustic adjustment device 100 is connected to the respective microphones of the models 62, 64, 66, 68, and acquires a signal based on the acoustic signal collected by the sound collection part 150. The acoustic adjustment device 100 is connected to the vehicle via a connection part 70. The acoustic adjustment device 100 may adjust at least one of the level and phase of the acoustic signal output by the acoustic signal output part 170 by setting the filter coefficients of the IIR filter and/or FIR filter of the DSP in each adjustment mode. The setting of the filter coefficients in each adjustment mode may be stored in the memory part (not shown) for DSP settings provided in the vehicle 10.

The connection part 70 may be a connection interface such as USB (Universal Serial Bus). However, when the acoustic adjustment device 100 may access the memory part for DSP settings by wireless connection, the connection part 70 may be omitted.

Also, the adjustment part 122 may adjust the acoustic signal based on impulse response analysis. In this case, the adjustment part 122 may cause the acoustic signal output part 170 to output a TSP (Time Stretched Pulse) signal instead of a single impulse signal. In the case of performing analysis based on a single impulse, analysis is performed by outputting a signal having large sound pressure (energy) in a very short time. In the case of performing analysis based on a single impulse, since the impulse is single, the total energy is limited and the measurement time also becomes short. In this case, when environmental noise continuously exists, if the pulse is not captured at the moment of that short pulse, the impulse set as the measurement target may be buried in noise.

Also, in the case of acquiring an impulse response using a single impulse signal, since a peak of large sound pressure appears in a short measurement time, the range in which the speaker and equipment exhibit linear characteristics may be exceeded, or elastic deformation exceeding the linear domain may occur in reflection within the measurement space, and squeaking or rattling sounds may appear. In the case of using a TSP signal instead of a single impulse signal, the possibility of nonlinear distortion occurring during acquisition of the impulse response is also reduced.

On the other hand, a TSP signal is a signal that may be generated by a computer that continuously sweeps frequencies from a low frequency domain to a high frequency domain. The TSP signal is output by continuously sweeping the frequency and stretching the pulse. By continuously sweeping the frequency during a long measurement time, the energy of the signal is accumulated, and the total energy over the measurement time becomes large. In the case of acquiring an impulse response using a TSP signal, the sound collection part 150 collects the TSP signal, and thereafter, the impulse response is derived by convolving an inverse TSP signal that is the original TSP signal reversed. Compared to the case where the sound collection part 150 collects a single impulse signal, by collecting the TSP signal, the signal energy is distributed over the measurement time, and noise is converted by correlation processing, so results with a high signal-to-noise ratio (S/N ratio; Signal to Noise Ratio) and high measurement accuracy may be obtained.

Therefore, the control part 120 may control the plurality of speakers included in the acoustic signal output part 170 to output TSP signals, and the sound collection part 150 may collect the TSP signals. In this case, the acquisition part 132 may acquire a signal based on the TSP signal collected by the sound collection part 150. The generation part 134 may generate display information that shows, based on the acquired signal, the level difference and phase difference acquired at positions corresponding to both ears of each seat in the vehicle cabin of the vehicle 10, per frequency, over the frequencies that the TSP signal sweeps. The TSP signal is an example of an acoustic signal used for acoustic adjustment.

The display part 160 displays a graph and/or image based on the display information. Thereby, an inspector who views the display part 160 may grasp, per frequency, the level difference and phase difference generated at each seat from the acoustic signals output from the plurality of speakers included in the acoustic signal output part 170 in the vehicle 10.

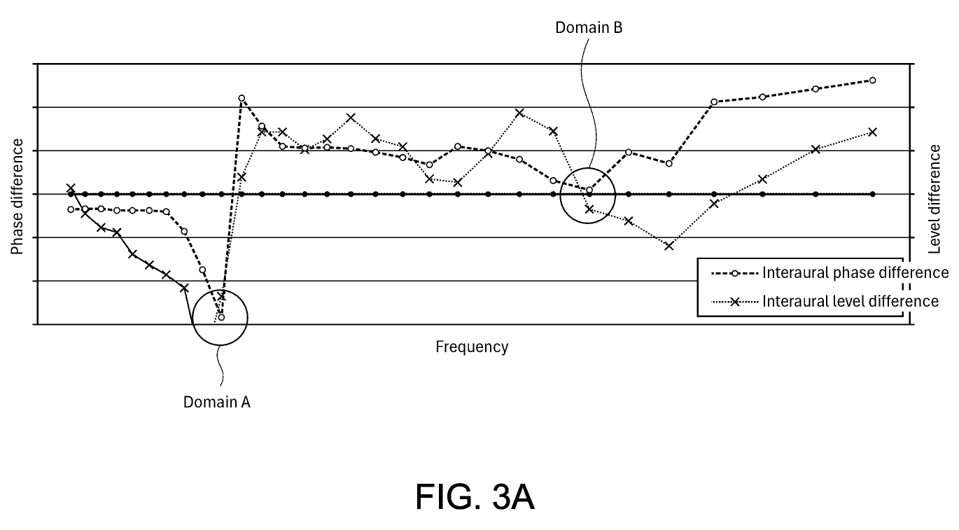

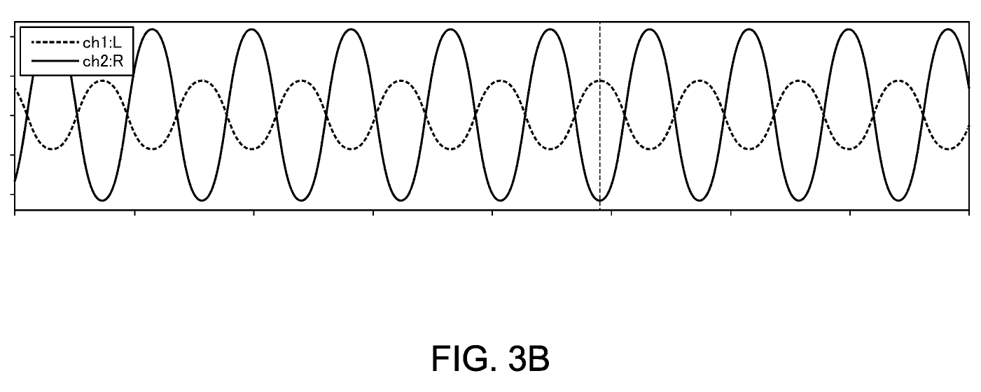

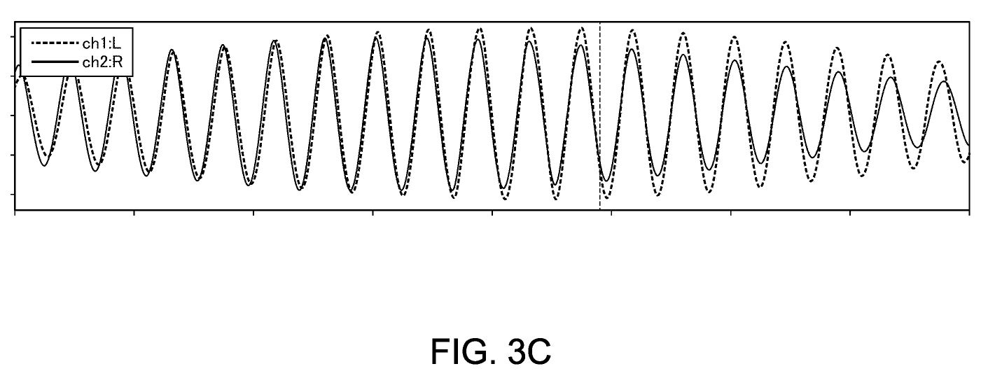

FIG. 3A is an example of a graph showing the interaural level difference and the interaural phase difference heard by an occupant in the vehicle cabin of the vehicle 10. The phase difference and level difference between the sound heard by the right ear of the occupant are shown with the sound heard by the left ear of the occupant as a reference. In the figure, the horizontal axis is frequency, and the vertical axis is phase difference or level difference (amplitude difference). FIG. 3A is a figure for description, and to show an overview, the horizontal axis and vertical axis are shown as a figure in arbitrary unit (a.u.).

In the frequency band corresponding to domain A, both the line showing the phase difference of the heard sound and the line showing the level difference of the heard sound have large absolute values in the vertical axis direction. In this case, the phase difference and level difference of the sound heard by the right ear are large relative to the sound heard by the left ear.

In the frequency band corresponding to domain B, both the line showing the phase difference of the heard sound and the line showing the level difference of the heard sound have small absolute values in the vertical axis direction, and are positioned close to the line showing the sound heard by the left ear of the occupant. In this case, the phase difference and level difference of the sound heard by the right ear are small relative to the sound heard by the left ear.

FIG. 3B is an example of a graph showing the waveforms of acoustic signals heard by both ears in the domain A. Unlike FIG. 3A which showed the phase difference and level difference, FIG. 3B shows the actually heard sound, and an example where the heard sound is a sine wave is shown. In the figure, the horizontal axis is frequency, and the vertical axis is amplitude. The horizontal axis and vertical axis are shown as a figure in arbitrary unit (a.u.).

An example is shown where the amplitude of the sine wave heard by the right ear is smaller than half of the amplitude of the sine wave shown for the sound heard by the left ear, and the phase difference is also approximately 180 degrees. In such a case, the sound image based on the heard acoustic signal also becomes unclear.

FIG. 3C is an example of a graph showing the waveforms of acoustic signals heard by both ears in the domain B. Similar to FIG. 3B, an example where the heard sound is a sine wave is shown. In the figure, the horizontal axis is frequency, and the vertical axis is amplitude. The horizontal axis and vertical axis are shown as a figure in arbitrary unit (a.u.).

In this FIG. 3C, although there is a slight deviation between the sound heard by the left ear and the sound heard by the right ear, the waveforms are substantially identical. In this case, the sound image shown by the acoustic signals heard from both ears, that is, the sound image perceived in the domain B, becomes clearer compared to the sound image perceived in the domain A. Therefore, in a graph showing the phase difference and level difference as in FIG. 3A, by adjusting such that the values are concentrated at the center of the vertical axis, the waveforms of the acoustic signals heard between both ears become similar, and the sound image becomes clear.

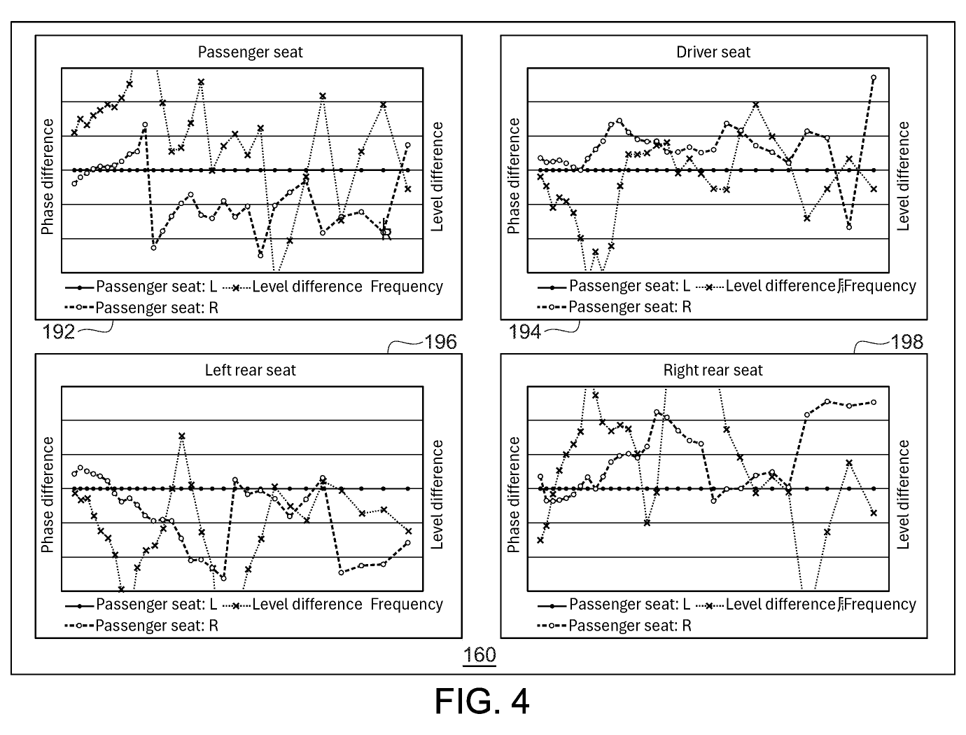

FIG. 4 is an example of a diagram shown on the display part 160, showing the level difference and phase difference heard by both ears for each seat. The display part 160 includes a passenger seat information display part 192, a driver seat information display part 194, a left rear seat display part 196, and a right rear seat display part 198.

In the present embodiment, the passenger seat information display part 192, the driver seat information display part 194, the left rear seat display part 196, and the right rear seat display part 198 show the phase difference and level difference for each seat with reference to the acoustic signal heard by the left ear, similar to FIG. 3A. The inspector causes the adjustment part 122 to adjust the acoustic signal heard at each seat via the input interface 162.

In this way, the generation part 134 generates first display information showing at least one of a graph showing the relationship between the interaural level difference and frequency, and a graph showing the relationship between the interaural phase difference and frequency. Furthermore, the generation part 134 may generate such first display information for each seat. Since the vehicle 10 of the present embodiment has four seats, four images as shown in the figure are generated. Therefore, the generation part 134 may generate first display information showing at least one of the relationship between the interaural level difference and frequency and the relationship between the interaural phase difference and frequency in the acoustic signal for each of the plurality of positions corresponding to both ears of the listener. The display part 160 may display a graph and/or image based on the first display information. Furthermore, the generation part 134 updates the first display information in response to the adjustment part 122 adjusting the phase based on the parameter input via the input interface 162, and operates to collectively display the updated first display information, the second display information defining the input interface 162, and the input parameter on the display part 160. Thereby, the inspector may grasp at least one of the set parameter and the resulting relationship between the interaural level difference and frequency, and the relationship between the interaural phase difference and frequency, with high visibility and objectivity, and can improve the efficiency of the adjustment work.

As described with reference to FIGS. 3B and FIG. 3C, the smaller the phase difference and level difference, the more similar the waveforms indicated by the left and right acoustic signals become, and the clearer the sound image becomes. The inspector refers to the image displayed on the display part 160 and instructs, via the input interface 162, the adjustment part 122 to clearly adjust the sound image of the acoustic signal for the desired seat.

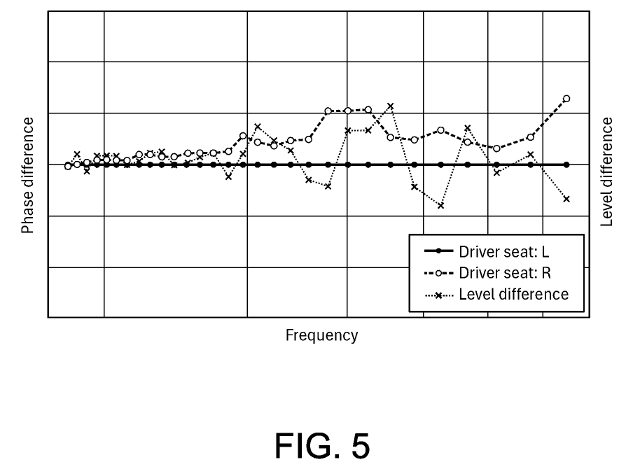

FIG. 5 is an example of a graph showing the level difference and phase difference heard by both ears after adjustment by the adjustment part 122 for the driver seat information display part 194. The adjustment part 122 adjusts the acoustic signal of the graph shown in the driver seat information display part 194 of FIG. 4, and in the graph after adjustment, the level difference and phase difference of the acoustic signal are suppressed.

In this case, the generation part 134 updates the display information in response to the adjustment part 122 adjusting at least one of volume, frequency, phase, and sound quality. After the adjustment part 122 adjusts the acoustic signal as shown in FIG. 5, the acquisition part 132 may acquire signals based on acoustic signals output from a plurality of speakers included in the acoustic signal output part 170 provided in the vehicle cabin of the vehicle 10, at positions corresponding to both ears of the listener provided in the vehicle cabin. The generation part 134 generates display information for display on the display part, showing at least one of the relationship between the interaural level difference and frequency, and the relationship between the interaural phase difference and frequency in the acoustic signal. Thereby, the generation part 134 updates the display information.

The display part 160 displays information of the acoustic signal based on the updated display information. The inspector may refer to the updated information on the display part and determine whether to further adjust the acoustic signal. In a case where the inspector determines, based on the updated display information, that the adjustment of the acoustic signal by the adjustment part 122 is not sufficient, the inspector may instruct the adjustment part 122 via the input interface 162 to further adjust the phase difference and/or level difference of the acoustic signal. On the other hand, in a case where the inspector determines that the adjustment of the acoustic signal by the adjustment part 122 is sufficient, the acoustic signal output part 170 may continue to output the adjusted acoustic signal without performing further adjustment.

As described above, the acoustic adjustment assistance device of the present embodiment displays acoustic characteristics (such as level difference and phase difference) for clarifying the sound image per frequency with respect to the sound image of the acoustic signal heard in the vehicle cabin of the vehicle 10. In this way, the acoustic adjustment assistance device may assist in adjusting (tuning) the acoustic signal such that the occupants in the vehicle cabin of the vehicle 10 can comfortably listen to the acoustic signal by visualizing the acoustic characteristics. Therefore, even a person who is not accustomed to sound quality evaluation can easily perform sound quality tuning as an inspector, and this leads to accuracy improvement of sound quality tuning, man-hour reduction, and prevention of personalization.

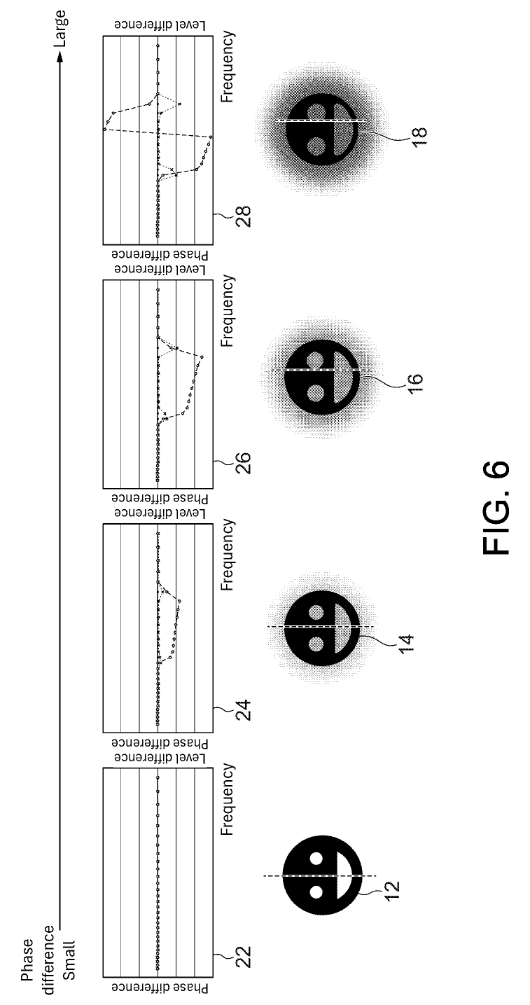

FIG. 6 shows an example of displaying an image for showing the interaural phase difference in the acoustic signal heard by both ears. An image 12, an image 14, an image 16, and an image 18 are images for intuitively showing the phase difference in a graph 22, a graph 24, a graph 26, and a graph 28, respectively.

In this way, the generation part 134 may generate display information including an image representing a sound image formed by acoustic signals output from a plurality of speakers included in the acoustic signal output part 170, based on at least one of the relationship between the interaural level difference and frequency and the relationship between the interaural phase difference and frequency in the acoustic signal.

In a case where the phase of the acoustic signal heard between both ears is equal and the level is also equal (that is, the level difference is small), the sound image is perceived as being located in front of the listener (for example, when the head of the listener is viewed in plan view from above the head, in front of the head and on the perpendicular bisector of the two points where both ears are located).

In a case where the phase difference between both ears is large, for example, in opposite phase (shifted by approximately 180 degrees), the sound image perceived by the listener becomes unclear, and the listener may feel unnatural sound source localization. Specifically, the listener may feel a localization as if the sound disappears inside the head and floats outside, and may feel a sensation that the sound source is floating above the head, inside the head, or in space. Alternatively, the listener may become unable to perceive the sound source as being clearly in front of themselves, the localization of the sound source in the depth direction becomes unclear, and the listener may feel as if the sound source is wrapping around to the rear of the listener, or may feel as if the sound source is localized toward the rear in the depth direction. In this way, in a case where the phase difference between both ears is large, the listener may perceive the sound source as being localized further toward the rear in the depth direction or as wrapping around outside the head.

Therefore, in order to visually represent the sound image perceived in this way by an image, the generation part 134 may generate display information including an image representing a sound image with higher resolution as the interaural level difference is smaller and the interaural phase difference is smaller in a predetermined frequency band.

FIG. 6 shows an example in which the phase difference becomes larger in a specific frequency band and approaches opposite phase as proceeding from graph 22 to graph 28. Also, it is assumed that there is virtually no level difference in the acoustic signal. Here, in the frequency band where the phase difference occurs, the listener perceives the sound image as if the localization of the sound source is shifted in the direction where the phase advances faster. In this way, the generation part 134 may generate display information including an image representing a sound image indicating that the sound source localization is shifted in the direction of the sound source where the phase advances faster as the interaural phase difference in a predetermined frequency band is larger.

Then, the listener perceives that the degree of shift is larger as the phase difference is larger. Therefore, the generation part 134 may generate display information in which a chain line is arranged on the image representing the sound image, and the image representing the sound image is arranged at a greater distance from the chain line as the interaural phase difference is larger. Also, the listener perceives an acoustic signal including both a frequency band where a large phase difference occurs and a frequency band where a relatively small phase difference occurs as a blurred sound image as a result of the localization of the sound source not converging. The generation part 134 generates display information in a manner that allows more intuitive and visual recognition by the image representing the sound image that the clarity of the sound image perceived in this way changes depending on the phase difference. For this purpose, for example, the generation part 134 may generate display information that outputs a low resolution image shown such that the contour of the image representing the sound image becomes blurred and unclear according to the clarity of the sound image, as shown in FIG. 6.

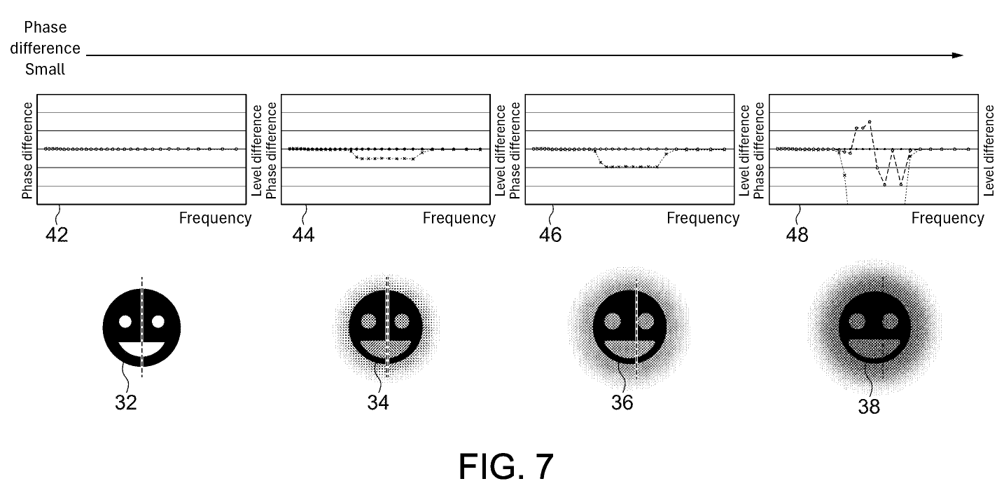

FIG. 7 shows an example of displaying an image for indicating the interaural level difference in an acoustic signal listened to by both ears. An image 32, an image 34, an image 36, and an image 38 are images for intuitively indicating the level difference in a graph 42, a graph 44, a graph 46, and a graph 48, respectively. In FIG. 7, it is assumed that there is virtually no phase difference.

As already described, when the phase of the acoustic signal listened to between both ears is equal and the level is also equal, the sound image is perceived as being located in front of the listener. On the other hand, when the level difference of the acoustic signal listened to between both ears is large, the sound source localization may be perceived as being shifted in the direction of the sound source with the larger level. For example, in a case where two speakers are respectively arranged on the left and right of the listener, the sound source localization may be perceived as shifting in the direction where the level is larger for the left and right sound sources, and therefore shifting in the left-right direction.

Also, an acoustic signal including both a frequency band where a large level difference occurs and a frequency band where a relatively small level difference occurs is perceived as a blurred sound image as a result of the sound source localization not converging. In order to visually express by an image that the clarity of the sound image perceived in this way changes depending on the level difference, the generation part 134 may generate display information including a high resolution image representing a sound image with a clear contour as the interaural level difference in a predetermined frequency band is smaller. Also, the generation part 134 may generate display information including an image representing a sound image indicating that the sound source localization is shifted toward a direction of a sound source having a larger level as the interaural level difference in the predetermined frequency band is larger.

In FIG. 7, an example is shown in which the level difference becomes larger in a specific frequency band as proceeding from the graph 42 to the graph 48. In this embodiment as well, similar to FIG. 3A and the like, the level of the acoustic signal listened to by the right ear with the left ear as a reference is shown. Therefore, graphs are shown in which the level of the acoustic signal listened to by the right ear is smaller relative to the level of the acoustic signal listened to by the left ear as proceeding from the graph 42 to the graph 48. In this case, the sound image is perceived as shifting to the left side in a specific frequency band as proceeding from the graph 42 to the graph 48, and as a result, the image representing the sound image is shown as becoming blurred and unclear. In this way, the generation part 134 may generate display information including, as an image representing a sound image, a low resolution image that becomes more unclear as the interaural level difference in a predetermined frequency band is larger.

Also, the images 12, 14, 16, and 18 showing the phase difference of the acoustic signal listened to by both ears may be based on the sum of the phase differences at the frequencies swept by the TSP signal, and may also be based on statistical information such as an average value.

Here, for example, the memory part 140 may store data relating to the position of the sound source localization perceived by a listener when various interaural level differences and/or phase differences are given per frequency. When the control part 120 performs frequency analysis, the generation part 134 may divide the frequencies swept by the TSP signal into a plurality of predetermined frequency bands, and predict the sound source localization based on the relationship between frequency and the interaural level difference, and/or the relationship between frequency and the interaural phase difference.

The generation part 134 may generate display information including an image representing a sound image based on statistical information of the interaural level difference and/or the interaural phase difference and frequency in a predetermined frequency band. The generation part 134 may generate display information including an image representing a sound image based on statistical information such as an average value or variance of the interaural level difference at each of a plurality of frequencies and/or the interaural phase difference at each of a plurality of frequencies.

The generation part 134 may predict the sound source localization in a plurality of frequency domains for the frequencies swept by the TSP signal. The generation part 134 may perform prediction of the sound source localization by setting a two-dimensional coordinate system with the midpoint of the line segment connecting both ears of the listener as the origin, looking down at the head from above the listener, and using the perpendicular bisector of both ears as one of the two axes. For example, the generation part 134 may predict the sound source localization as a position in the two-dimensional coordinate system measured from the origin, based on the amount of movement of the sound image perceived by the interaural level difference and phase difference in the left-right direction and front-rear direction of the listener in the two-dimensional coordinate system. Alternatively, the generation part 134 may predict the sound image perceived in a three-dimensional coordinate system in which an XYZ-system is set as a right-hand system perpendicular to the X-axis, with the midpoint of the line segment connecting both ears of the listener as the origin, looking down at the head from above the listener (for example, set in the Z direction), and using the perpendicular bisector of both ears as the X-axis. The generation part 134 may predict the sound source localization as a position in the two-dimensional coordinate system measured from the origin, based on the amount of movement of the sound image in the left-right direction, front-rear direction, and up-down direction of the listener due to the interaural level difference and phase difference in the three-dimensional coordinate system.

The generation part 134 may plot the predicted positions of the sound source localization in a plurality of frequency domains on two-dimensional coordinates or three-dimensional coordinates for the frequencies swept by the TSP signal. The generation part 134 may integrate the prediction results of the sound source localization obtained for each of the plurality of frequency domains and calculate the centroid obtained by averaging the predicted positions as the sound source localization at the frequencies swept by the TSP signal. Here, the calculation of the centroid performed by the generation part 134 is not limited to taking an average with the same weight for each of the plurality of frequencies, and the generation part 134 may take a weighted average after performing processing such as weighting the frequency bands that easily affect the displacement of the sound image. The generation part 134 may generate display information by determining the drawing position based on the sound source localization derived as the centroid in the image representing the sound image.

Furthermore, the generation part 134 may evaluate the variance of the sound source localization when integrating the prediction results as the degree of ambiguity of the sound source localization. For example, when the variation of the sound source localization in a plurality of frequency bands is large, the variance becomes large, so the generation part 134 may generate display information having a resolution corresponding to the variance of the sound source localization based on a predetermined relationship between the variance of the sound source localization and the resolution, such that the larger the variance, the more unclear the contour becomes in the image representing the sound image.

In this way, the generation part 134 may express the centroid of each predicted position as the sound source localization and the variance as the resolution of the image, and may use a two-dimensional image or a three-dimensional image that two-dimensionally or three-dimensionally expresses the relative positional relationship between the position of the listener's head and the sound source localization as display information including an image representing the sound source localization. The sound source localization derived as the centroid and the variance when deriving the centroid described above are derived based on statistical information such as the distribution and variation of the sound source localization determined in a plurality of frequency bands perceived by the listener when the interaural level difference or phase difference changes per frequency.

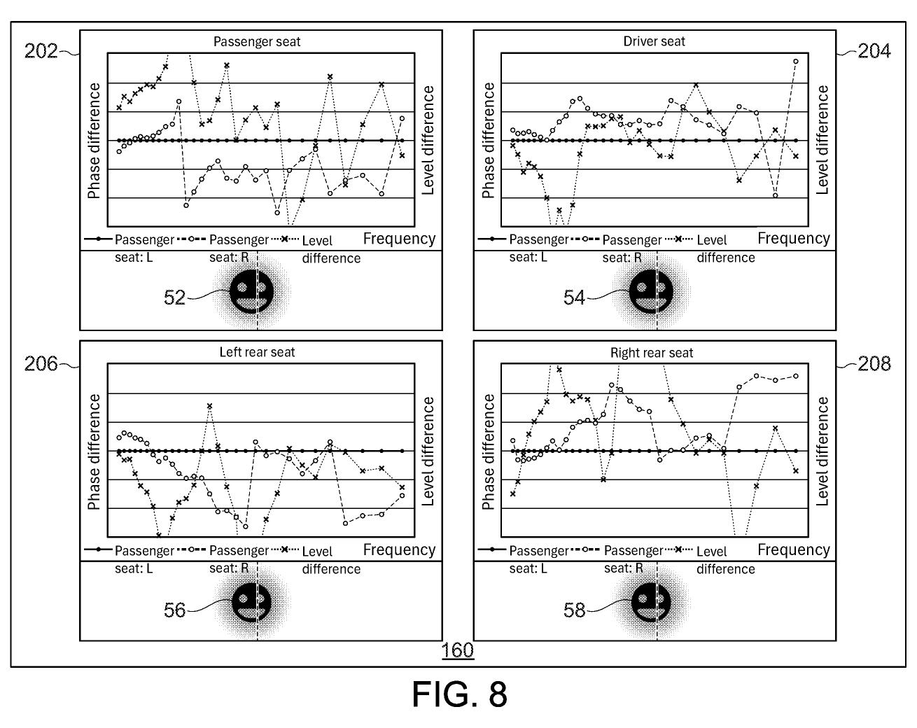

FIG. 8 is an example of a diagram showing the level difference and phase difference heard by both ears for each seat, shown on the display part 160. In FIG. 8, similar to FIG. 4, images showing the level difference and phase difference for the passenger seat, driver seat, left rear seat, and right rear seat are displayed.

In the present embodiment, in a passenger seat information display part 202, a driver seat information display part 204, a left rear seat display part 206, and a right rear seat display part 208, images 52, 54, 56, 58 representing the sound images described in FIGS. 6 and 7 for each seat are shown together with the graphs. This allows the inspector to intuitively grasp the blur, contour, size, and localization of the sound image even when the inspector does not have specialized knowledge about the sound image. The inspector may refer to the image displayed on the display part 160 and instruct, via the input interface 162, the adjustment part 122 to clearly adjust the sound image of the acoustic signal for a desired seat. This makes it possible to easily perform sound quality tuning through an intuitive sound image even when the inspector is not accustomed to sound quality evaluation, which leads to accuracy improvement of sound quality tuning, man-hour reduction, and prevention of personalization.

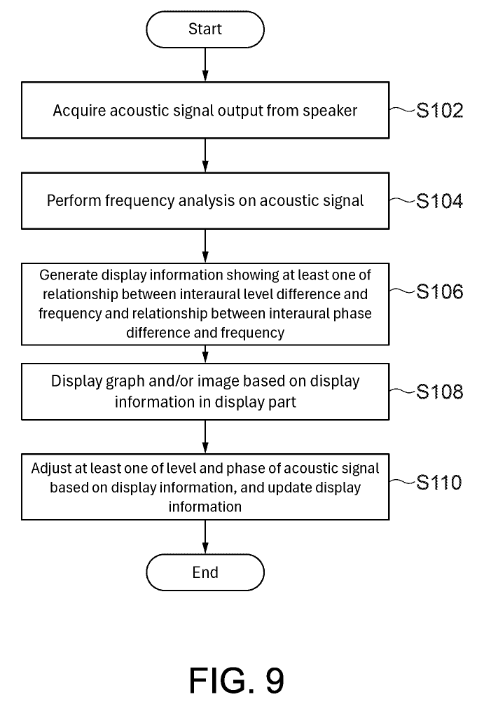

FIG. 9 is an example of a flow diagram showing processing performed in the acoustic adjustment assistance method according to the present embodiment. The processing performed in the acoustic adjustment assistance method according to the present embodiment includes steps S102 to S110.

The acquisition part 132 acquires a signal based on the acoustic signal output from the speaker (S102). The acoustic signal output from the speaker may be an acoustic signal for acquiring an impulse response, and may be a TSP signal.

The generation part 134 performs frequency analysis on the acquired acoustic signal (S104). The generation part 134 may acquire an impulse response by performing convolution integration on the signal acquired by the acquisition part 132 using an inverse TSP signal for the TSP signal output by the acoustic signal output part 170. This allows the interaural level difference and phase difference to be acquired per frequency for the acoustic signal collected at positions corresponding to both ears in the frequency band swept by the TSP signal.

The generation part 134 generates display information showing at least one of the relationship between the interaural level difference and frequency, and the relationship between the interaural phase difference and frequency (S106). The generation part 134 may generate the display information based on the acquired impulse response.

The control part 120 causes the display part 160 to display a graph and/or image based on the display information (S108). The inspector instructs the adjustment part 122 to clarify the volume of the acoustic signal output by the acoustic signal output part 170 via the input interface 162 based on the display on the display part 160. In this case, adjustment may be made such that the average of the sound images for individual occupants becomes clear for occupants in all seats in the vehicle cabin of the vehicle 10. Alternatively, adjustment may be made such that the sum of the level differences or phase differences of each seat is minimized. Furthermore, in the case where occupants sit only in some seats, the level difference or phase difference of the acoustic signal output by the acoustic signal output part 170 may be adjusted such that the sound image becomes clear only in the seats where the occupants sit.

Accordingly, the inspector causes the adjustment part 122 to adjust the sound quality of the acoustic signal based on the display information. The generation part 134 updates the display information (S110). The display part 160 displays a graph and/or image based on the updated display information. As described above, the sound image indicated by the acoustic signal heard in the vehicle cabin is clarified.

As described above, the acoustic adjustment assistance method of the present embodiment visualizes acoustic characteristics (such as level difference and phase difference) for clarifying the sound image per frequency for the sound image of the acoustic signal heard in the vehicle cabin of the vehicle 10. This may assist the inspector in adjusting the acoustic signal such that the occupants in the vehicle cabin of the vehicle 10 can comfortably listen to the acoustic signal. Therefore, even a person who is not accustomed to sound quality evaluation can easily perform sound quality tuning, and this leads to accuracy improvement of sound quality tuning by the inspector, man-hour reduction, and prevention of personalization.

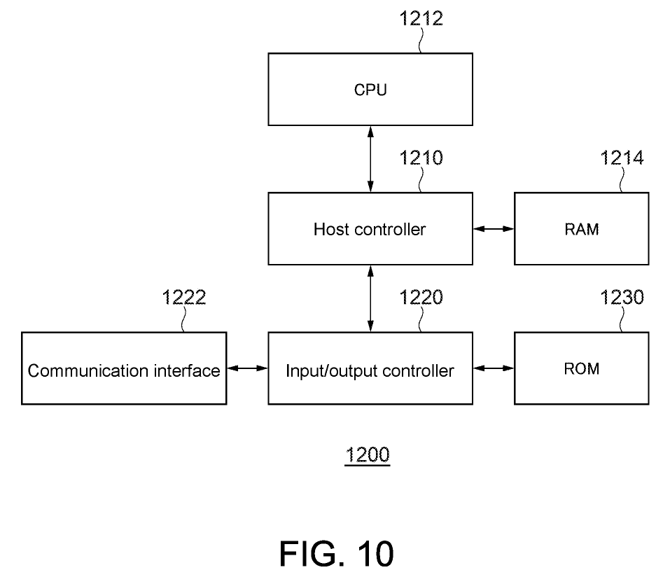

FIG. 10 shows an example of a computer 1200 that may wholly or partially embody aspects of the present embodiment. A program installed in the computer 1200 may cause the computer 1200 to function as operations associated with an apparatus according to embodiments of the disclosure or as one or more “parts” of the apparatus. Alternatively, the program may cause the computer 1200 to execute the operations or the one or more “parts”. The program may cause the computer 1200 to execute a process according to embodiments of the disclosure or stages of the process. Such a program may be executed by a CPU 1212 to cause the computer 1200 to execute specific operations associated with some or all of the blocks in the flowcharts and block diagrams described in this specification.

The computer 1200 according to the present embodiment includes a CPU 1212 and a RAM 1214, which are interconnected by a host controller 1210. The computer 1200 also includes a communication interface 1222 and an input/output unit, which are connected to the host controller 1210 via an input/output controller 1220. The computer 1200 also includes a ROM 1230. The CPU 1212 operates according to programs stored in the ROM 1230 and the RAM 1214, thereby controlling each unit.

The communication interface 1222 communicates with other electronic devices via a network. A hard disk drive may store programs and data used by the CPU 1212 in the computer 1200. The ROM 1230 stores therein a boot program or the like executed by the computer 1200 upon activation, and/or programs dependent on the hardware of the computer 1200. Programs are provided via a computer-readable recording medium such as a CD-ROM, USB memory, or IC card, or via a network. The programs are installed in the RAM 1214, which is also an example of a computer-readable recording medium, or the ROM 1230, and are executed by the CPU 1212. Information processing described in these programs is read by the computer 1200 and brings about cooperation between the programs and the various types of hardware resources described above. An apparatus or method may be configured by realizing operations or processing of information according to the use of the computer 1200.

For example, in the case of communication being executed between the computer 1200 and an external device, the CPU 1212 may execute a communication program loaded into the RAM 1214 and instruct the communication interface 1222 to perform communication processing based on processing described in the communication program. Under the control of the CPU 1212, the communication interface 1222 reads transmission data stored in a transmission buffer domain provided in the RAM 1214 or a recording medium such as a USB memory, transmits the read transmission data to a network, or writes reception data received from the network to a reception buffer domain or the like provided on the recording medium.

Also, the CPU 1212 may cause all or a necessary part of a file or database stored in an external recording medium such as a USB memory or the like to be read into the RAM 1214, and may execute various types of processing on the data on the RAM 1214. The CPU 1212 may then write back the processed data to the external recording medium.

Various types of information such as various types of programs, data, tables, and databases may be stored in a recording medium and may be subjected to information processing. The CPU 1212 may execute various types of processing on data read from the RAM 1214, including various types of operations, information processing, condition determination, conditional branching, unconditional branching, searching/replacing of information, and the like, described throughout the disclosure and specified by instruction sequences of programs, and writes back the results to the RAM 1214. Also, the CPU 1212 may search for information in files, databases, and the like in the recording medium. For example, in the case of a plurality of entries each having an attribute value of a first attribute associated with an attribute value of a second attribute being stored in the recording medium, the CPU 1212 may search for an entry matching a condition in which an attribute value of the first attribute is specified from among the plurality of entries, read an attribute value of the second attribute stored in the entry, and thereby obtain an attribute value of the second attribute associated with the first attribute satisfying a predetermined condition.

The program or software module described above may be stored in a computer-readable storage medium on the computer 1200 or near the computer 1200. Also, a recording medium such as a hard disk or RAM provided in a server system connected to a dedicated communication network or the Internet may be configured as a computer-readable storage medium, thereby providing the program to the computer 1200 via a network.

A computer-readable medium may include any tangible device capable of storing instructions executed by an appropriate device. As a result, a computer-readable medium having instructions stored thereon includes a product including instructions that may be executed to create means for performing operations specified in flowcharts or block diagrams. Examples of computer-readable media may include electronic storage media, magnetic storage media, optical storage media, electromagnetic storage media, semiconductor storage media, and the like. More specific examples of computer-readable media may include floppy (registered trademark) disks, diskettes, hard disks, random access memory (RAM), read-only memory (ROM), erasable programmable read-only memory (EPROM or flash memory), electrically erasable programmable read-only memory (EEPROM (registered trademark)), static random access memory (SRAM), compact disc read-only memory (CD-ROM), digital versatile disc (DVD), Blu-ray (RTM) disc, memory stick, integrated circuit card, and the like.

Computer-readable instructions may include either source code or object code written in any combination of one or more programming languages. The source code or object code includes conventional procedural programming languages. The conventional procedural programming languages may be assembler instructions, instruction set architecture (ISA) instructions, machine instructions, machine-dependent instructions, microcode, firmware instructions, state setting data, or object-oriented programming languages such as Smalltalk (registered trademark), JAVA (registered trademark), C++, and the like, and “C” programming language or similar programming languages. The computer-readable instructions may be provided to a processor or programmable circuit of a general-purpose computer, special-purpose computer, or other programmable data processing device, either locally or via a wide area network (WAN) such as a local area network (LAN), the Internet, or the like. The processor or programmable circuit may execute the computer-readable instructions to create means for performing operations specified in flowcharts or block diagrams. Examples of processors include the computer processors, processing units, microprocessors, digital signal processors, controllers, microcontrollers, and the like.

The above description has been made using the embodiments, but the technical scope of the disclosure is not limited to the scope described in the above embodiments. It is apparent to those skilled in the art that various modifications or improvements may be added to the above embodiments. It is apparent from the description of the patent claims that forms with such modifications or improvements may also be included in the technical scope of the disclosure.

It should be noted that the execution order of each process such as operations, procedures, steps, and stages in the devices, systems, programs, and methods shown in the patent claims, specification, and drawings may be realized in any order unless specifically indicated as “before” or “prior to” and unless the output of a previous process is used in a subsequent process. Even if the operation flow in the patent claims, specification, and drawings is described using “first,” “next,” and the like for convenience, this does not mean that implementation in this order is mandatory.

What is claimed is:

1. An acoustic adjustment assistance device, comprising:
an acquisition part that acquires signals based on acoustic signals output from a plurality of output channels provided in a vehicle cabin of a vehicle at positions corresponding to both ears of a listener provided in the vehicle cabin; and
a generation part that generates first display information for display on a display part, the first display information showing at least one of a relationship between an interaural level difference and a frequency and a relationship between an interaural phase difference and the frequency in the acoustic signal.

2. The acoustic adjustment assistance device according to claim 1, wherein the generation part generates the first display information showing at least one of a graph showing the relationship between the interaural level difference and the frequency and a graph showing the relationship between the interaural phase difference and the frequency.

3. The acoustic adjustment assistance device according to claim 1, wherein the generation part generates the first display information showing at least one of the relationship between the interaural level difference and the frequency and the relationship between the interaural phase difference and the frequency in the acoustic signal, for each of the plurality of positions corresponding to both ears of the listener.

4. The acoustic adjustment assistance device according to claim 1, wherein the generation part generates the first display information including an image representing a sound image formed by the acoustic signals output from the plurality of output channels, based on at least one of the relationship between the interaural level difference and the frequency and the relationship between the interaural phase difference and the frequency in the acoustic signal.

5. The acoustic adjustment assistance device according to claim 4, wherein the generation part generates the first display information including the image representing the sound image, based on at least one of statistical information of an interaural level difference and statistical information of an interaural phase difference in a predetermined frequency band.

6. The acoustic adjustment assistance device according to claim 4, wherein the generation part generates the first display information including the image representing the sound image with higher resolution as an interaural level difference is smaller and an interaural phase difference is smaller in a predetermined frequency band.

7. The acoustic adjustment assistance device according to claim 4, wherein the generation part generates the first display information including the image representing the sound image showing that sound source localization is shifted toward a direction of a sound source having faster phase advance as an interaural phase difference in a predetermined frequency band is larger.

8. The acoustic adjustment assistance device according to claim 4, wherein the generation part generates the first display information including the image representing the sound image showing that sound source localization is shifted toward a direction of a sound source having a larger level as an interaural level difference in a predetermined frequency band is larger.

9. The acoustic adjustment assistance device according to claim 1, wherein the output channel is a speaker.

10. An acoustic adjustment device, comprising:
the acoustic adjustment assistance device according to claim 1; and
an adjustment part that adjusts at least one of a level and a phase of the acoustic signals output from the plurality of output channels, respectively.

11. The acoustic adjustment device according to claim 10, wherein the generation part updates the first display information in response to the adjustment part adjusting at least one of the level and the phase.

12. The acoustic adjustment device according to claim 11,
wherein the generation part further generates second display information for display on the display part an input interface via which parameters related to the phase of each of the acoustic signals output from the plurality of output channels are input,
the adjustment part is configured to acquire the parameters related to the phase of the acoustic signal for each of the plurality of output channels via the input interface displayed on the display part, and
the generation part updates the first display information in response to the adjustment part adjusting the phase based on the parameters input via the input interface, and collectively displays the updated first display information, the second display information, and the input parameters on the display part.

13. An acoustic adjustment assistance method, comprising:
acquiring signals based on acoustic signals output from a plurality of output channels provided in a vehicle cabin of a vehicle at positions corresponding to both ears of a listener provided in the vehicle cabin; and
generating display information for display on a display part, the display information showing at least one of a relationship between an interaural level difference and a frequency and a relationship between an interaural phase difference and the frequency in the acoustic signal.

14. A non-transitory recordable medium recording a program that, when executed by a computer, causes the computer to function as:
an acquisition part that acquires signals based on acoustic signals output from a plurality of output channels provided in a vehicle cabin of a vehicle at positions corresponding to both ears of a listener provided in the vehicle cabin; and
a generation part that generates display information for display on a display part, the display information showing at least one of a relationship between an interaural level difference and a frequency and a relationship between an interaural phase difference and the frequency in the acoustic signal.
